(19) United States
(12) Patent Application Publication
(10) Pub. No.: US 2016/0209185 A1
(43) Pub. Date: Jul. 21, 2016

(54) REMOTE CONTROL TARGET AND METHOD OF USE

(71) Applicant: George Ford, Scottsdale, AZ (US)

(72) Inventor: George Ford, Scottsdale, AZ (US)

(21) Appl. No.: 14/995,010

(22) Filed: Jan. 13, 2016

Related U.S. Application Data
(60) Provisional application No. 62/103,650, filed on Jan. 15, 2015.
(60) Provisional application No. 62/153,070, filed on Apr. 27, 2015.

(51) Int. Cl. F41J 9/02; G05D 1/00; G05B 15/02

(52) U.S. Cl. CPC F41J 9/02; G05B 15/02; G05D 1/0011

(57) ABSTRACT

A remote control target and method of using same is provided. A remote control target is used outdoors or at an indoor shooting range and guided over terrain by a remote control. An interchangeable target is mounted on a wheeled carriage assembly comprising a motor wherein the remote control controls movement of the target-bearing carriage over terrain. The remote control target may include a gimbal mounted between the target and the carriage, wherein the gimbal rotates the target with respect to the carriage. In some embodiments, the target comprises an explosive charge, wherein the target explodes when struck in a defined area by a fired projectile, creating a striking visual and auditory display to confirm a “kill.”

### CROSS REFERENCE TO RELATED APPLICATION[S]

This application claims priority to U.S. Provisional Patent Application entitled “REMOTE CONTROL EXPLODING TARGET AND METHOD OF USE,” Ser. No. 62/103,650, filed Jan. 15, 2015, and also claims priority to U.S. Provisional Patent Application entitled “REMOTE CONTROL EXPLODING TARGET AND METHOD OF USE,” Ser. No. 62/153,070, filed Apr. 27, 2015, the disclosures of which are hereby incorporated entirely herein by reference.

### BACKGROUND OF THE INVENTION

1. Technical Field

This invention generally relates to targets for weapons and more particularly to moving targets controlled by a remote control.

2. State of the Art

Recreational hunters, gun enthusiasts, and others seeking to become more proficient with firearm use utilize targets for practice. These targets, like a traditional bull's eye pattern printed on paper for example, are typically affixed to a mounting which remains stationary as the shooter fires upon the target. Often times, this mounting is a considerable distance from the shooter. After shooting at the target from a distance, the shooter must examine the target to determine whether the shooter hit the target, and if so, whether the strike was near the aimed-for location on the target. This requires retrieving the target for close examination.

Additionally, mounted targets are often stationary. Shooting at a stationary target, regardless of the shooting position and/or range to the target, can rapidly become repetitive. Shooting at a moving target, however, is considerably more challenging and requires more skill than shooting at a stationary target. A stationary target is not realistic. When hunting, for example, an animal is often walking or running rather than standing still. Currently available targets do not provide realistic, exciting, or adequate training for a shooter seeking to become proficient at hitting a moving target.

Accordingly, what is needed is a realistic and engaging device to train shooters to become proficient at hitting both a stationary and a moving target in realistic situations.

### DISCLOSURE OF THE INVENTION

This invention relates to targets for weapons. Specifically, embodiments of the present invention relate to moving targets controlled by a remote operator and which indicate a weapon strike by exploding.

An embodiment includes a remote control target system comprising a carriage comprising a motor and wheels; a target coupled to the carriage; and a remote control, wherein the carriage is guided over terrain in response to the remote control controlling the motor.

Another embodiment includes a remote control target system comprising a remote control carriage comprising a motor and wheels; a target; a gimbal coupled between the target and the carriage; and a first remote control, wherein the remote control carriage is guided over terrain in response to input from the remote control, and wherein the gimbal rotates the target about an axis transverse to a top surface of the remote control carriage.

Yet another embodiment includes a method of using a remote control target system, the method comprising mounting at least one target in a human like form on at least one carriage of a remote control target system; controlling the carriage remotely; and performing non-autonomous tactical training, wherein the tactical training comprises controlling the at least one remote control target system in one of multiple target scenarios, concealed carry scenarios, sudden attack scenarios, home defense scenarios, shoot/don't shoot scenarios, close quarters scenarios, rear attach scenarios, use in 180 degree to 360 degree movement scenarios, team competition/team building scenarios, weapon transition scenarios, and precision shooting scenarios.

The foregoing and other features and advantages of the invention will be apparent to those of ordinary skill in the art from the following more particular description of the invention and the accompanying drawings.

### BRIEF DESCRIPTION OF THE DRAWINGS

Some of the embodiments will be described in detail, with reference to the following figures, wherein like designations denote like members.

FIG. 1 is a side view of a remote control target, according to embodiments of the present invention.

FIG. 2 is a perspective view of a carriage for a remote control target, according to embodiments of the present invention.

FIG. 3 is a side view of a remote control target, according to embodiments of the present invention.

FIG. 4 is a side view of a remote control target with clay pigeons coupled thereto, according to embodiments of the present invention.

FIG. 5 is a flowchart of steps for a method of using a remote control target, in accordance with embodiments of the present invention.

FIG. 6 is a front view of a remote control target according to embodiments of the present invention.

FIG. 7 is a perspective view of a carriage of a remote control target according to embodiments of the present invention.

FIG. 8 is a perspective view of a remote control target according to embodiments of the present invention.

FIG. 9 is a perspective view of a carriage of a remote control target with a frame according to embodiments of the present invention.

FIG. 10 is a perspective view of a remote control target with a three dimensional target according to embodiments of the present invention.

FIG. 11 is a flowchart of steps for a method of mounting and using a remote control target, in accordance with embodiments of the present invention.

### DETAILED DESCRIPTION OF EMBODIMENTS OF THE INVENTION

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the disclosure. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification, the singular forms “a,” “an,” and “the” include plural referents, unless the context clearly dictates otherwise.

As mentioned above, the disclosed invention relates to targets for weapons. Specifically, embodiments of the present invention relate to moving targets controlled by a remote operator.

To become proficient at shooting, a hunter or other recreational shooter is usually limited to a target mounted in a fixed position. This provides a challenge which may be made more difficult only by increasing the distance from the shooter to the target. Embodiments of the present invention, however, provide a remotely controlled moving target. Shooting at a target, which may be moving randomly or erratically, greatly increases the challenge and excitement of firearm and other weapons training. Additionally, in some embodiments the target explodes when struck in the proper location. Additionally, the target can take many shapes and forms, either flat or three-dimensional which, when combined with remote-control steering, presents any number of target silhouettes to the shooter.

Embodiments of a remote control target are used outdoors or at an indoor range and guided over terrain by a remote operator are disclosed and described in detail herein. An interchangeable target, in some embodiments, is mounted on a wheeled carriage assembly comprising a motor wherein the remote control controls movement of the target-bearing carriage over terrain. In some embodiments, the target comprises an explosive charge, wherein the target explodes when struck in a defined area by a fired projectile creating a striking visual and auditory display. Details of various example embodiments of the remote control target and its method of use are disclosed herein.

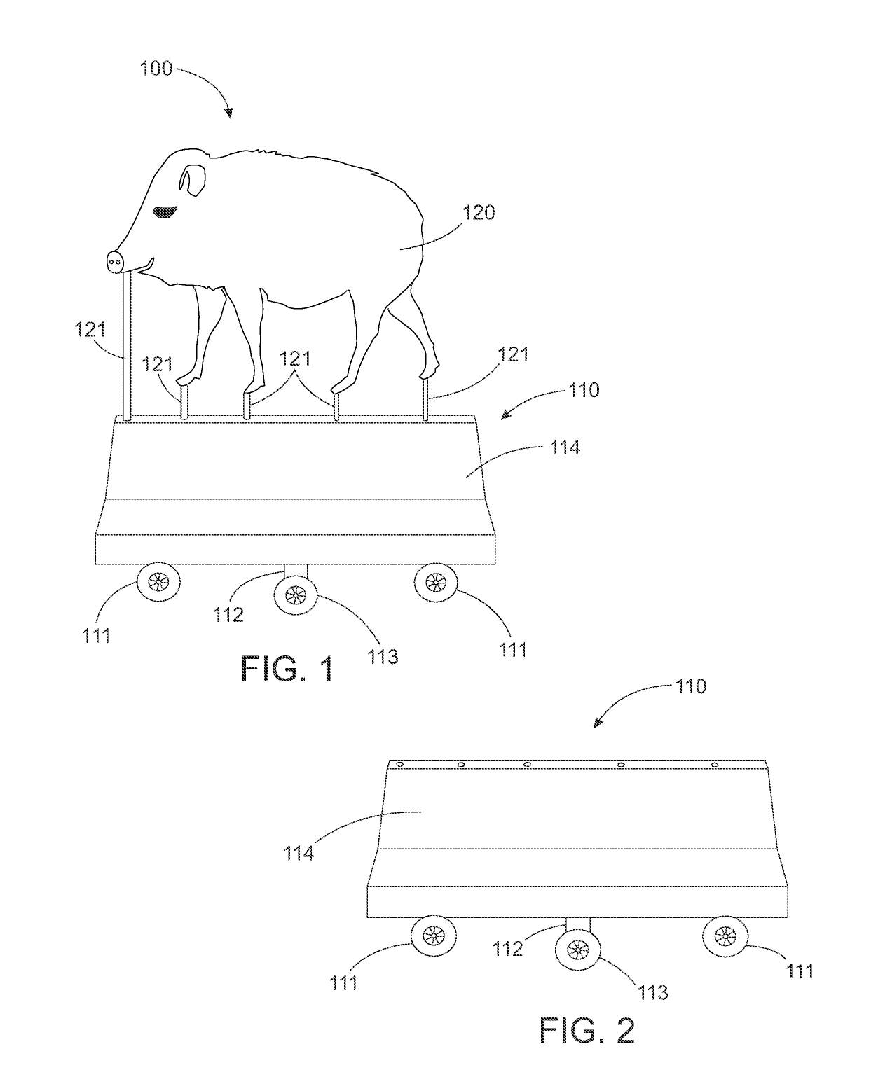

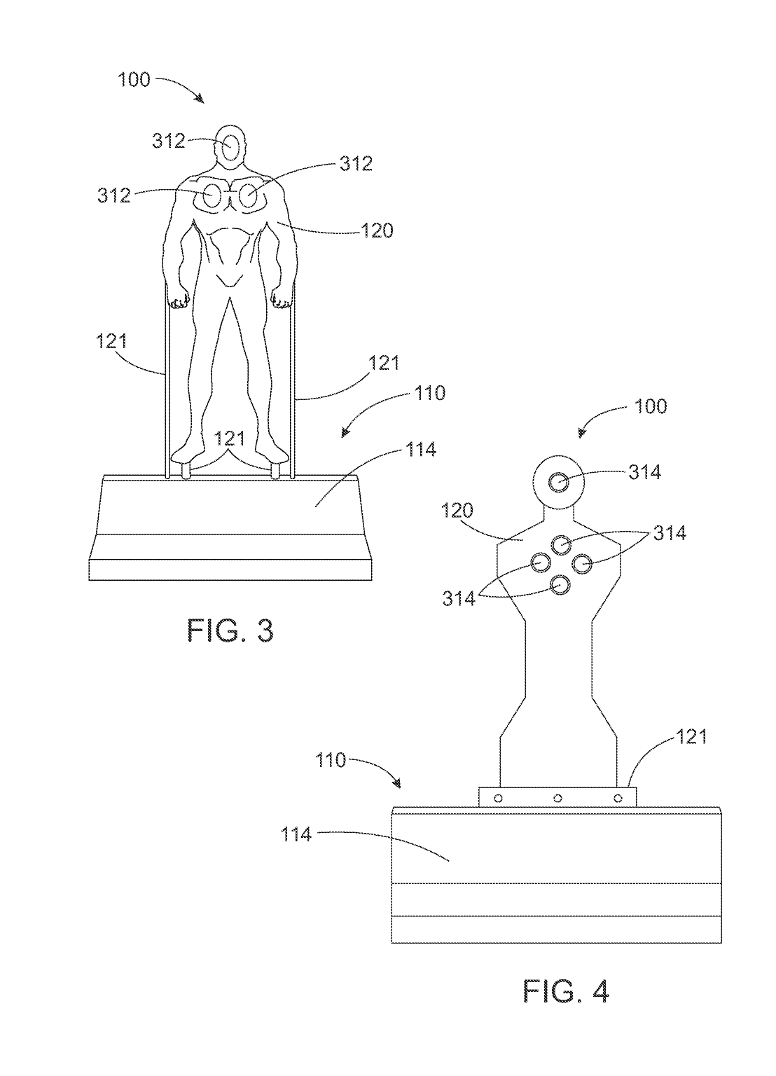

Referring to the several drawing, figures, FIGS. 1-3 show an embodiment of a remote control target 100; according to the invention. Target 120 is any suitable target. Target 120 is one of any of a number of shapes and forms in some embodiments. In the embodiment shown in FIG. 1, target 120 is a visage of a peccary, also commonly known as a javelina, although target 120 may be fashioned in the appearance of other game animals, such as a turkey, a pheasant, a boar, and other animals. Other examples include but are not limited to a traditional “bull's eye,” or any other shape. Target 120 may be a generally flat surface. In some embodiments, target 120 is a three dimensional form. In some embodiments, target 120 is a complete three-dimensional likeness of an animal or other three-dimensional shape. Target 120 may be a human form with additional target marks 312 as shown in FIG. 3.

Many materials can be used to construct target 120, however relatively soft and/or brittle materials are advantageous in embodiments of the invention wherein target 120 comprises an explosive, discussed further herein below. Some examples of suitable soft and/or brittle materials include terra cotta, other clays, paper, pressed-paper, heavy cardboard, paper-balsa wood composites, composite materials comprising a woven cloth, other composite materials; and soft synthetic materials such as nylon, polyethylene, or polypropylene, as well as foam or any other similar material. These examples are not meant to be limiting.

A target 120 is coupled to a carriage 110 by a target mount 121. Target mount 121 mechanically couples target 120 to carriage 110. In some embodiments, target mount 121 is removably coupled to target 120. In some embodiments, target mount 121 is removably coupled to carriage 110. Target mount 121 also serves to support target 120 in a generally upright orientation so as to present a desired profile to a shooter aiming a weapon at target 120. In some embodiments, target mount 121 is rigid. In some embodiments, target mount 121 is flexible, such as a coiled flexible spring for example, and allows target 120 to sway while carriage 110 is in motion over irregular terrain.

Carriage 110 comprises a drive wheel 111. Drive wheel 111 is coupled to a motor which causes drive wheel 111 to turn, propelling carriage 110 across a surface, such as a floor surface or outdoor terrain. The motor is any suitable motor or other device sufficient to propel carriage 110 across terrain. Drive wheel 111 is one or a plurality of wheels, as in the embodiment shown in FIGS. 1-3.

Referring to FIG. 4, another embodiment of the present invention includes a remote control target 100. Target 120 is a shape of a 2-dimensional human-like form. A target 120 is coupled to a carriage 110 by a target mount 121. Target mount 121 mechanically couples target 120 to carriage 110. In some embodiments, target mount 121 is removably coupled to target 120. In some embodiments, target mount 121 is coupled to housing 114 of carriage 110. Target mount 121 also serves to support target 120 in a generally upright orientation so as to present a desired profile to a shooter aiming a weapon at target 120. In some embodiments, target mount 121 is rigid. In some embodiments, target mount 121 is flexible, such as a coiled flexible spring for example, and allows target 120 to sway while carriage 110 is in motion over irregular terrain. Target mount 121 may also be in the form of a bracket wherein target 120 is coupled between two corresponding plates or members of target mount 121. In these embodiments, target mount 121 includes a space between two plates, wherein target 120 is coupled within the space between the two plates and secured in place.

Target 120 may include clay pigeon targets 314 replaceably coupled to target 120. As clay pigeon targets 314 are shot and destroyed, they are easily replaced. Clay pigeon targets 314 may be coupled to target 120 by a friction fit on target 120. For example, target 120 may include a circular grooves that correspond to a lips of clay pigeon targets 314, wherein the lips of clay pigeon targets 314 are friction fit within the circular grooves.

Carriage 110 comprises a drive wheel 111. Drive wheel 111 is coupled to a motor which causes drive wheel 111 to turn, propelling carriage 110 across a surface, such as a floor surface or outdoor terrain. The motor is any suitable motor or other device sufficient to propel carriage 110 across terrain.

In some embodiments, carriage 110 is steerable. In such embodiments, a plurality of motors 115 power a plurality of drive wheels 111 at differential speeds to propel carriage 110 in any direction and to turn carriage 110. Control of motor(s) 115 to effect steering of carriage 110 is effected via any suitable remote control. For example, a suitable remote control may include a commercially available remote control such as a radio-control system used to remotely control and steer a model vehicle In some embodiments, carriage 110 comprises a motor, a power source, an integrated circuit (“IC”), and a receiver. Receiver, in some embodiments, receives a signal transmitted by a remote user controlling target 100. Receiver then sends the signal to IC which decodes the information in the signal and determines whether power from power source is sent to one or more motor(s) mechanically coupled to drive wheel(s) 111 to propel carriage 110 in the desired direction. It will be understood that the motors may be coupled to drive wheel(s) 111 such that motor(s) control the speed and direction of rotation of drive wheel(s) 111 and the turning of drive wheel(s) 111 to control path of travel of carriage 110. In other words, motors control whether carriage 110 moves forward, backward, turns left, turns right or a combination of moving in a direction forward or backward while turning right or left.

A stabilizer wheel 113 coupled to a stabilizer bar 112. Stabilizer wheel 113, in some embodiments, acts to resist overturning of remote control target 100 when operating target 110 over terrain or aggressively turning and maneuvering target 100. Stabilizer wheel 113 is mounted at the terminus of a stabilizer bar 112. Stabilizer bar mechanically couples stabilizer wheel 113 to a carriage 110 and acts in concert with stabilizer wheel 113 to resist overturning of carriage 110 during remote control operation of remote control target 100.

Housing 114, in some embodiments, covers fragile components of carriage 110, such as, but not limited to a motor, a power source, and an electronic receiver for example, and provides a degree of protection against damage from gunfire to carriage 110 and its subcomponents. Accordingly, housing 114, in some embodiments, is constructed from a suitable material, such as hardened steel, a para-aramid synthetic fiber, or other material of similar hardness and resilience. In some embodiments, housing 114 is removably coupled to carriage 110, facilitating removal and replacement when carriage 110 becomes damaged by gunfire.

In some embodiments, there is one target mount 121. In some embodiments, there is a plurality of target mounts 121. There may be multiple target mounts 121 evenly distributed across a long edge of carriage 110, however the location of target mount(s) 121 on an edge of carriage 110 is not meant to be limiting. In some embodiments, target mount(s) 121 are fixedly coupled to carriage 110 and removably coupled to target 120, wherein target 120 is replaced by removing remnants of a damaged or exploded target 120 from target mount(s) 121 and coupling a replacement target 120 to target mount(s) 120. In some embodiments, target mount(s) 121 are fixedly coupled to target 120 and removably coupled to carriage 110, wherein target mount(s) 121 are removed from carriage 110 along with remnants of a damaged or exploded target 120 and a replacement target 120 fixedly coupled to replacement target mount(s) 121 is removably coupled to carriage 110.

Remote control target 100, in some embodiments, comprises an explosive. The explosive is a small explosive charge sufficient to substantially fragment target 120 in an explosion easily visible to the shooter at a distance from remote control target 100. In some embodiments, the explosive causes a loud explosion. Material comprising the explosive is any one of several stable explosive materials or compounds. In some embodiments, remote control target 100 further comprises a detonator. In embodiments comprising the detonator, the detonator causes detonation of the explosive and the resulting destruction of target 120 in a visible and/or audible display and may be controlled remotely by the remote control. In these and other embodiments, a projectile fired from a weapon by a shooter strikes target 120 at a physical location coupled to the explosive. Kinetic energy from the fired projectile may cause the explosive to explode directly, or through the intermediate action of the detonator. In some embodiments, detonation of the explosive is caused by a fired projectile striking any part of target 120. In some embodiments, the composition, amount, and location of the explosive is created to allow a fired projectile to cause detonation of the explosive only when a fired projectile strikes a specific area or location of target 120. For example, target 120 may be constructed in the three-dimensional shape of a deer and the explosive is chosen such that detonation only occurs when target 120 is struck in a location which projects over the corresponding anatomic location of the target-deer's heart or other vital organs indicating a “kill.” When a remote user steers carriage 110, the shooter must properly aim and time her/his shot in order to strike a vital area presented by target 120 to cause detonation of the explosive.

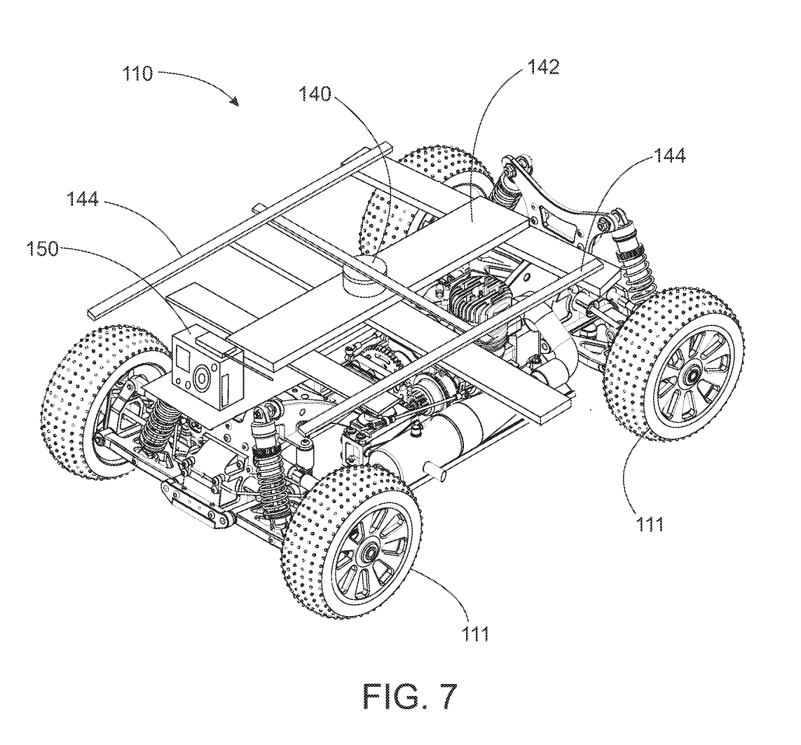

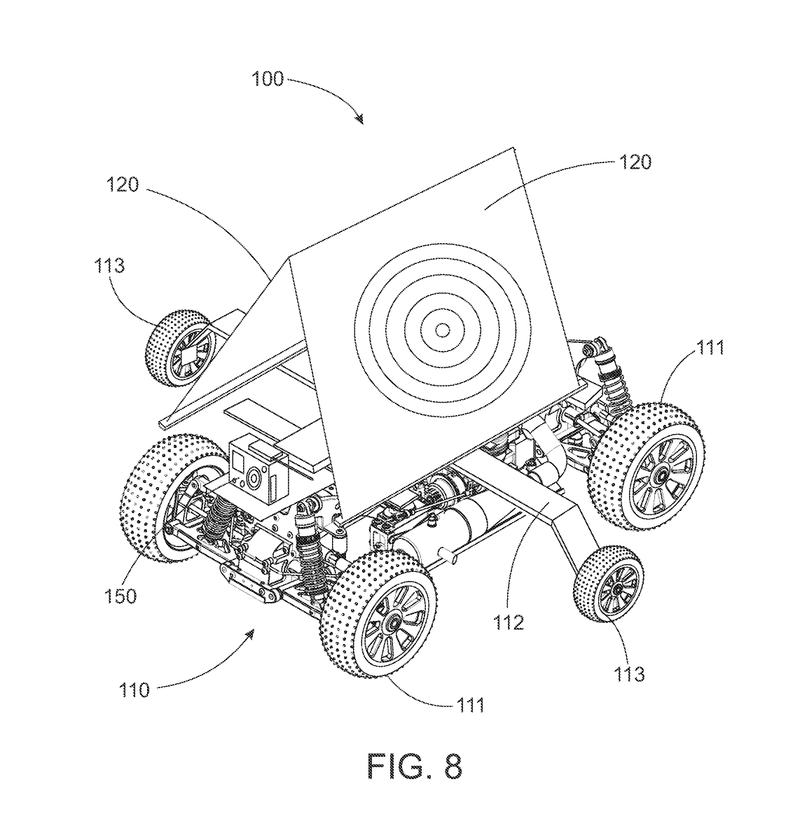

As shown in FIGS. 7-10, a remote control target 100 may include a target 120 is coupled to a carriage 110 by a gimbal 140 coupled between a gimbal support structure 142 and a target mount 144. In some embodiments, target mount 144 is removably coupled to target 120. In some embodiments, target mount 144 is removably coupled to carriage 110. Target mount 144 also serves to support target 120 in a generally upright orientation so as to present a desired profile to a shooter aiming a weapon at target 120. In some embodiments, target mount 144 is rigid. In some embodiments, target mount 144 is flexible, such as a coiled flexible spring for example, and allows target 120 to sway while carriage 110 is in motion over irregular terrain.

Carriage 110 comprises a drive wheel 111. Drive wheel 111 is coupled to a motor which causes drive wheel 111 to turn, propelling carriage 110 across a surface, such as a floor surface or outdoor terrain. The motor is any suitable motor or other device sufficient to propel carriage 110 across terrain. Drive wheel 111 is one or a plurality of wheels, as in the embodiment shown in FIGS. 7-10.

In some embodiments, carriage 110 is steerable. In such embodiments, a plurality of motors power a plurality of drive wheels 111 at differential speeds to propel carriage 110 in any direction and to turn carriage 110. Control of motor(s) to effect steering of carriage 110 is effected via any suitable remote control. It will be understood that the motors may be coupled to drive wheel(s) 111 such that motor(s) control the speed and direction of rotation of drive wheel(s) 111 and the turning of drive wheel(s) 111 to control path of travel of carriage 110. In other words, motors control whether carriage 110 moves forward, backward, turns left, turns right or a combination of moving in a direction forward or backward while turning right or left. Further, carriage 110 includes suspension 146, wherein carriage 110 in some embodiments includes full independent suspension 146 for improved ride and drivability over various terrain types.

Gimbal 140 operates to maintain the orientation of target 120 regardless of the direction of travel of carriage 110. Gimbal 140 is coupled to a gimbal support structure 142. Gimbal support structure 142 is coupled in a fixed position to carriage 110. Gimbal 140 is also coupled to target mount 144, wherein gimbal 140 rotates target mount 144. In operation, gimbal 140 maintains the target is a desired orientation regardless of direction of travel b carriage 110. Gimbal 140 may be controlled by a remote control. In some embodiments, carriage 110 is controlled by a first remote control and gimbal 140 is controlled by a second remote control. In these embodiments, two operators may be utilized to control remote control target 100. In this way, the remote control target 100 is a non-autonomous target, or a thinking target that is human controlled, and thereby reacting as a human would. This is particularly helpful in certain training, such as tactical training.

Remote control target 100 further includes a camera 150 mounted to carriage 110. Gimbal 140 may be programmed to maintain the orientation always or programmed to vary the orientation over a period of use time. In other embodiment, gimbal 140 may include a “follow me” mode, wherein the gimbal rotates to follow camera 150. Gimbal 140 may be programmed to determine how sensitive the turning may be accomplished and how quickly the turning of gimbal 140 occurs after turning of carriage 110. In the follow me mode, gimbal 140 may make a smooth turn shortly after turning of carriage 110 to more realistically simulate the movement of certain target types. Camera 150 may also be used to allow an operator to steer carriage 110 in response to the video streaming from camera 150. This is helpful in instances where carriage 110 is operated out of view of the operator.

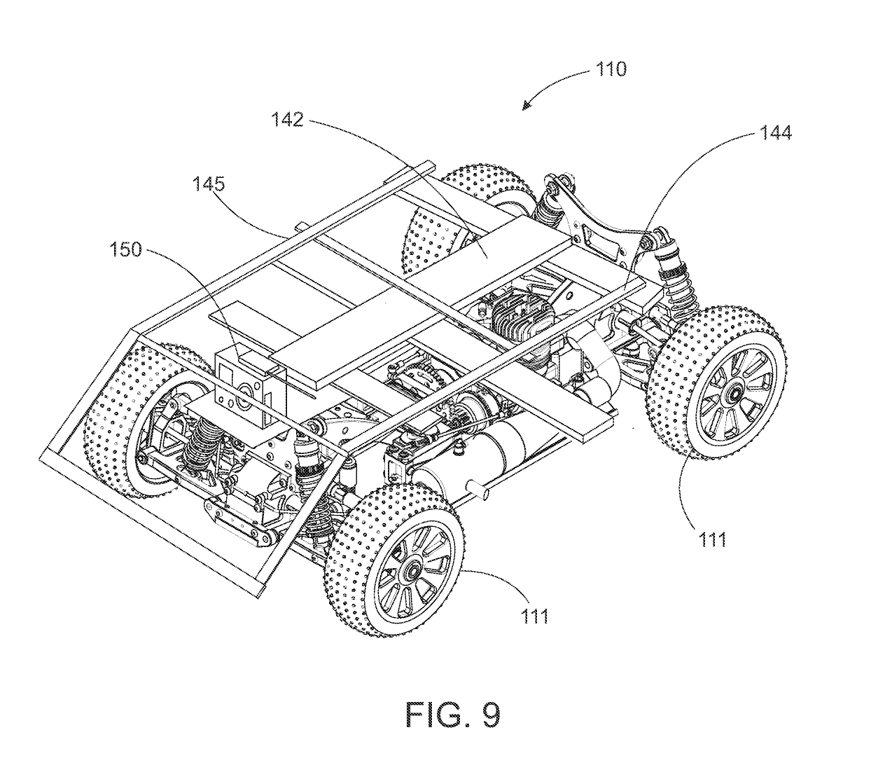

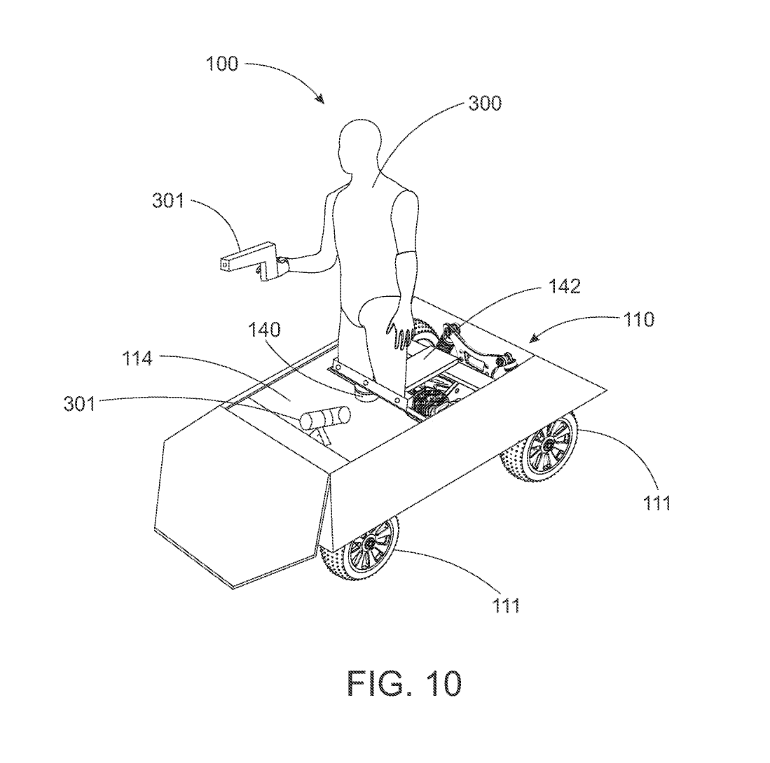

Referring specifically to FIGS. 9-10, embodiments include a remote control target system 100 that includes a remote control carriage 110 having a frame 145, a gimbal support structure 142, a motor and wheels 111. The system 100 further includes a target 300 and a gimbal 140 coupled between the target 300 and the carriage 110. A first remote control (not shown) may also be included as part of the system 100, wherein the remote control carriage 110 is guided over terrain in response to input from the first remote control. Gimbal 140 rotates the target 300 about an axis transverse to a top surface of the remote control carriage 110. In some embodiments, target 300 is removably coupled to gimbal 140. Wheels 111 of the carriage 110 further comprise a drive wheel coupled to the motor, and a power source coupled to the motor, wherein the motor causes the carriage 110 to move over terrain in response to receiving input from the remote control. Gimbal 140 rotates in response to input from the first remote control. In other embodiments system 100 includes a second remote control (not shown), wherein gimbal 140 rotates in response to input from the second remote control.

While target 300 may be any shape, as depicted in FIG. 10, target 300 is a three dimensional human likeness. Three dimensional human likeness target 300 may be coupled to gimbal 140 by a resilient member, wherein the resilient member allows the target 300 to rotate flat in response to a shooter hitting the target 300. Housing 114 of carriage 110 may include and opening in a portion of housing 110 allowing space for target 300 to rotate backward. The resilient member allows target 300 to react in a more lifelike manner wherein a target 300, such as a human likeness, may fall when shot or hit with a type of projectile. This is particularly useful in tactical training. System 100 may also include aids for improving and verifying accuracy. These embodiments may include clay pigeon targets 314 replaceably coupled to target 300 (see FIG. 4).

Remote control carriage 110 may include a frame 145 and housing 114 surrounding the remote control carriage 110 to protect the remote control carriage 110 from projectiles. Remote control carriage 110 may also include a camera 150. Camera 150 streams the viewing area of the lens of the camera 150 to an operator for allowing operation of the remote control carriage 110 without the remote control system 100 being in view of the operator.

System 100 may also include a weapon device 301 coupled to one of the remote control carriage 110 or the target 300. Weapon device 301 may shoot non-lethal ammunition. Further, weapon device 300 is remotely controlled. Weapon device may be remotely controlled through the first remote control, the second remote control, or another remote control.

In some embodiments, the remote control target 100 may include autonomous navigation. A computer may be utilized to control the navigation of the remote control target 100, wherein a path, route, speed, stops, turns acceleration, target orientation and the like are preprogrammed into an application that is utilized to control the remote control target 100. The computer may also have the ability to randomize certain aspects of the autonomous navigation. For example, and without limitation, the speed, the target orientation and periodic stops may be randomized, while the path and route traveled by the remote control target 100 is maintained according to what was programmed.

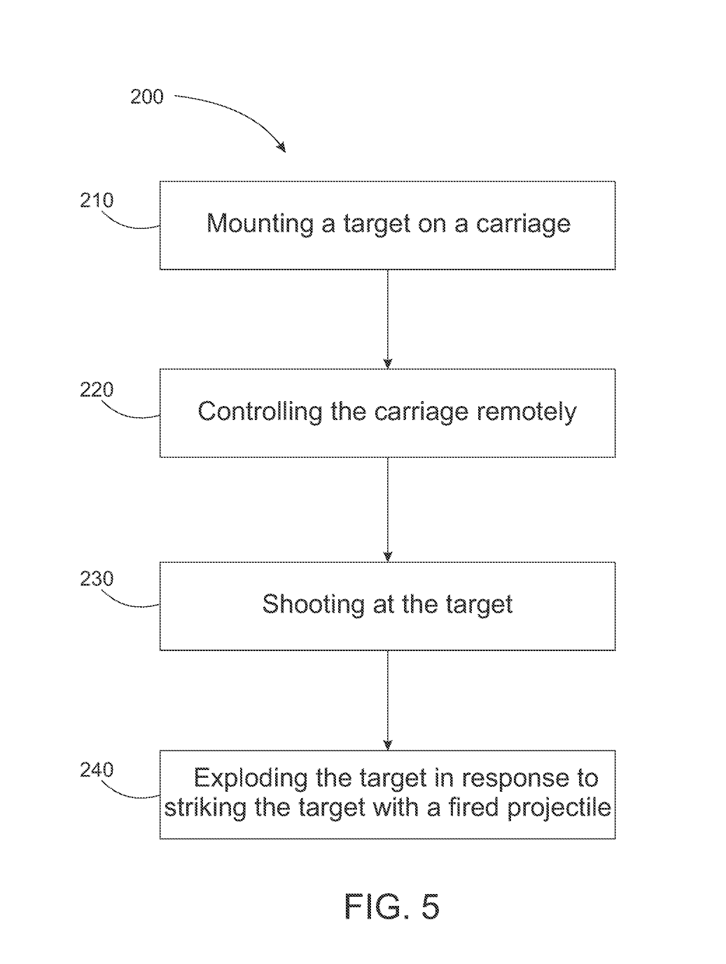

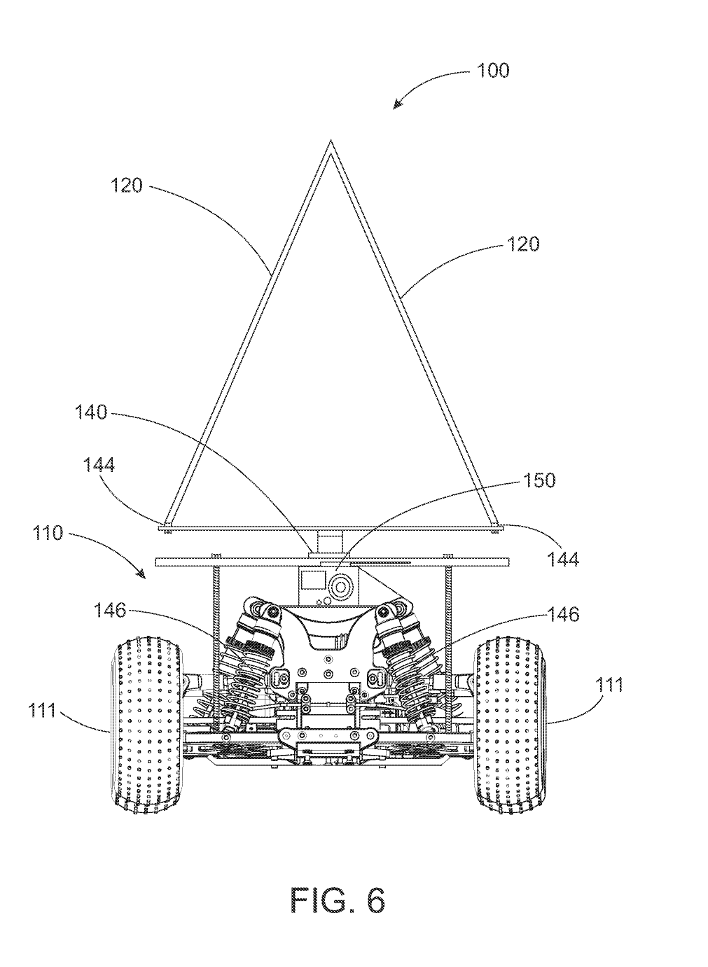

FIG. 5 is a flowchart diagramming a method 200 of using a remote control target. Method 200 may comprise mounting a target on a carriage (Step 210); controlling the carriage remotely (Step 220); shooting at the target (Step 230); and exploding the target in response to striking the target with a fired projectile (Step 240).

In some embodiments, Step 210 further comprises selecting a target. In some embodiments, the target comprises an explosive. In some embodiments, the target does not comprise an explosive.

Step 220 may be accomplished by a remote user holding a radio controlled received and transmitting signals to a radio received housed within a carriage of a remote control target. In this way, the remote user may regulate the speed and direction of a remote control target over a surface or terrain, providing a regular or erratically moving, challenging target for the shooter to “kill.”

In some embodiments, a rifle is used in shooting Step 230. In some embodiments a pistol or handgun is used in shooting step 230. In some embodiments, a shotgun is used in shooting Step 230. In some embodiments, a bow-and-arrow is used in shooting Step 230. These examples are not meant to be limiting. Any weapon for firing or launching a projectile toward a remote control target may be used in some embodiments.

In some embodiments with respect to Step 240, an explosive detonates in response to being struck with a fired projectile. In some embodiments, a detonator detonates an explosive in response to the detonator being struck by a fired projectile.

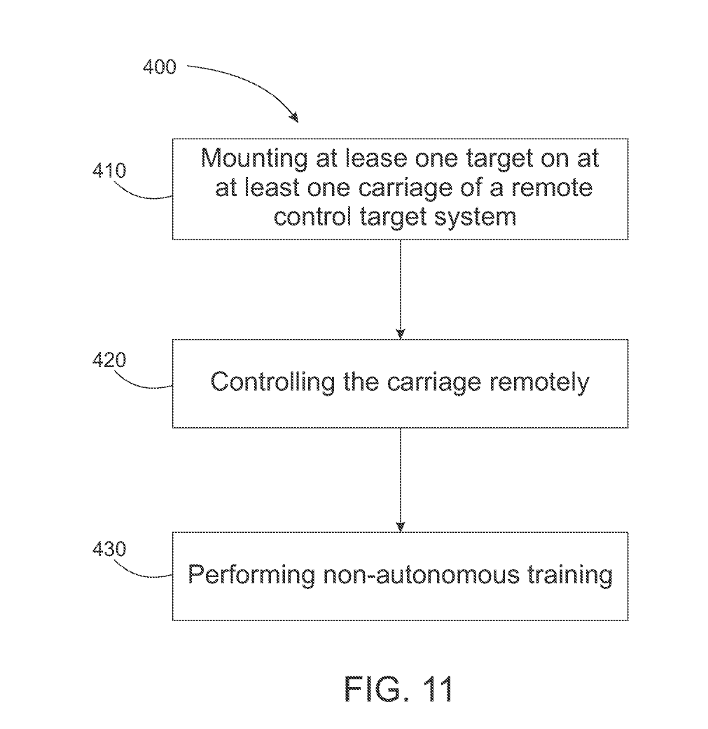

Referring again to the drawings, FIG. 11 depicts another method 400 of using a remote control target system, according to embodiments. Method 400 may include mounting at least one target in a human like form on at least one carriage of a remote control target system (Step 410); controlling the carriage remotely (Step 420); and performing non-autonomous tactical training (Step 430). Step 430 of performing non-autonomous training may include at least one of controlling the at least one remote control target system in one of multiple target scenarios, concealed carry scenarios, sudden attack scenarios, home defense scenarios, shoot/don't shoot scenarios, close quarters scenarios, rear attach scenarios, use in 180 degree to 360 degree movement scenarios, team competition/team building scenarios, weapon transition scenarios, and precision shooting scenarios. Other tactical training may be included. This include exploding the target to signal a hit, replacing a damaged target, performing hand-to-hand tactical moves and the like.

A remote control target has been described. Embodiments of the remote control target comprise a target mounted on a motorized, remote-control carriage assembly. An operator steers the carriage across terrain using a radio transmitter-receiver system or the like, providing a moving target, substantially challenging the shooter. The target is provided with an explosive charge, in some embodiments, rewarding the shooter with a dramatic explosion when the target is hit in the proper location for a “kill.”

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A remote control target system comprising:
a carriage comprising a motor and wheels;
a target coupled to the carriage; and
a remote control, wherein the carriage is guided over terrain in response to the remote control controlling the motor.

2. The system of claim 1, wherein the target is removably coupled to the carriage.

3. The system of claim 1, wherein the target is one of an animal likeness or a human likeness.

4. The system of claim 1, wherein wheels of the carriage further comprise a drive wheel coupled to the motor, and a power source coupled to the motor, wherein the motor causes the carriage to move over terrain in response to receiving input from the remote control.

5. The system of claim 1, wherein the carriage further comprises a stabilizer bar and a stabilizer wheel.

6. The system of claim 1, wherein the target further comprises an explosive.

7. A remote control target system comprising:
a remote control carriage comprising a motor and wheels;
a target;
a gimbal coupled between the target and the carriage; and
a first remote control, wherein the remote control carriage is guided over terrain in response to input from the remote control, and wherein the gimbal rotates the target about an axis transverse to a top surface of the remote control carriage.

8. The system of claim 7, wherein the target is removably coupled to the gimbal.

9. The system of claim 7, wherein wheels of the carriage further comprise a drive wheel coupled to the motor, and a power source coupled to the motor, wherein the motor causes the carriage to move over terrain in response to receiving input from the remote control.

10. The system of claim 7, wherein the gimbal rotates in response to input from the first remote control.

11. The system of claim 7, further comprising a second remote control, wherein the gimbal rotates in response to input from the second remote control.

12. The system of claim 7, wherein the target is a three dimensional human likeness.

13. The system of claim 12, wherein the three dimensional human likeness target is coupled to the gimbal by a resilient member, wherein the resilient member allows the target to rotate flat in response to a shooter hitting the target.

14. The system of claim 7, further comprising clay pigeon target replaceably coupled to the target.

15. The system of claim 7, wherein the remote control carriage comprises a frame and housing surrounding the remote control carriage to protect the remote control carriage from projectiles.

16. The system of claim 7, further comprising a camera, wherein the camera streams the viewing area of the lens of the camera to an operator for allowing operation of the remote control carriage without the remote control system being in view of the operator.

17. The system of claim 7, further comprising a weapon device coupled to one of the remote control carriage or the target.

18. The system of claim 17, wherein the weapon device comprises non-lethal ammunition.

19. The system of claim 17, wherein the weapon device is remotely controlled.

20. A method of using a remote control target system, the method comprising:
mounting at least one target in a human like form on at least one carriage of a remote control target system;
controlling the carriage remotely; and
performing non-autonomous tactical training, wherein the tactical training comprises controlling the at least one remote control target system in one of multiple target scenarios, concealed carry scenarios, sudden attack scenarios, home defense scenarios, shoot/don't shoot scenarios, close quarters scenarios, rear attach scenarios, use in 180 degree to 360 degree movement scenarios, team competition/team building scenarios, weapon transition scenarios, and precision shooting scenarios.
